(19) United States
(12) Patent Application Publication
(10) Pub. No.: US 2003/0209480 A1
(43) Pub. Date: Nov. 13, 2003

(54) Apparatus for separating a component from a fluid mixture

(76) Inventors: Klemens Kneifel, Geesthacht (DE); Rudolf Waldemann, Lauenburg (DE); Jan Wind, Lauenberg (DE); Regina Just, Geesthacht (DE); Klaus-Victor Peinemann, Geesthacht (DE); Wolfgang Albrecht, Teltow (DE); Roland Hilke, Teltow (DE); Karsten Kuhr, Luneburg (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/303,070

(22) Filed: Nov. 23, 2002

(30) Foreign Application Priority Data
May 7, 2002 (DE) 102 20 452.7

(51) Int. Cl. B01D 63/04

(52) U.S. Cl. 210/321.8; 210/335; 210/433.1; 210/435; 210/495; 210/321.89

(57) ABSTRACT

In an apparatus for separating at least one component from a fluid mixture, comprising a plurality of hollow fiber membrane frames through which a carrier fluid is conducted while the fluid mixture flows through the frames in a direction normal to the hollow fiber membranes supported in the frame, a plurality of frames are stacked on top of one another and shaped so that, together, they form a sealed tubular structure for guiding the fluid mixture past the hollow fiber membranes extending across the frames.

### BACKGROUND OF THE INVENTION

The invention resides in an apparatus for separating at least one component from a fluid mixture, that is from a gas mixture or a liquid mixture, wherein a carrier fluid flows through a plurality of parallel spaced hollow fiber membranes and a gas or liquid mixture is conducted through the spaces between the hollow fiber membranes in a direction essentially normal to the longitudinal axis of the hollow fiber membranes.

Such apparatus are also called gas/liquid contactors and such a contactor may be used for example for the separation of a gas mixture component by ad- or absorption in a carrier liquid.

Semi-permeable membranes are used in this connection as exchange structure and barrier between the gas mixture and the carrier fluid. The gas mixture flows over the outer surfaces of the membranes, which for such applications are usually the so-called hollow fiber membranes, whereas the carrier fluid is conducted through the lumina of the hollow fiber membranes. Hollow fiber membranes with very good compound transport properties are available for many applications such as ultra-filtration, dialysis, gas separation and pervaporation.

Unfortunately, the basically good transport properties of the membranes are utilized in praxis only to a small extent since the hollow fiber membranes are employed in separation apparatus of modular design wherein the material transport is restricted by design-based conditions such as non-uniform flow distribution, that is by channel formation, and slow flow speeds. Conventional apparatus using hollow fiber membranes as they are frequently utilized for liquid and gas separation processes, for example for reverse osmosis ultra-filtration and gas permeation, comprise a hollow fiber membrane bundle with incidental distribution of the hollow fiber membranes, which are provided at their ends with a suitable casting material and fixed in a tubular apparatus housing. The fluids to be treated flow parallel to the extension of the hollow fibers. The flow distribution at the outside of the hollow fibers is non-uniform and, within the hollow fiber membranes there is a high pressure loss.

The state of the art includes for example a woven web of hollow fiber membranes which is disposed in a square frame wherein each side of the frame includes a rectangular opening in communication with the hollow fibers which are open at their opposite ends. By way of these open ends, a permeate can be conducted away or the openings can be used as supply and discharge openings for conducting solutions through the hollow membranes. The frame with the hollow fiber membrane web is arranged normal to the axis of a tubular housing. A first fluid flows through the open area in the center of the frame normal to the axes of the hollow fibers and a second or even a third fluid flow through the lumina of the hollow fiber membranes of the woven web.

The manufacture of the woven netting of hollow fiber membranes is extremely complicated and expensive. The manufacturing process often causes the net-like arranged hollow fiber membranes to be damaged by the mechanical stresses to which they are subjected during the weaving process. They may be kinked or squeezed or stretched as a result of which the selection of the membrane materials and the dimensions of the hollow fiber membranes are quite limited. The high packing density of the hollow fiber membranes resulting from the weaving procedure may also be disadvantageous as it causes a relatively high pressure loss for the gas mixture passing through the woven structure. Furthermore, the provision of pressure-sealed separate feed and permeate spaces is very costly and results in a design requiring a multitude of sealing element which again increases the number of possible failure sources. In order to increase the reliability of the sealing structures, it has been tried to cement the individual elements supporting the hollow fiber membranes together which however prevents the replacement of individual damaged hollow fiber membrane elements and prevents the disassembly of the whole apparatus for maintenance.

It is therefore the object of the present invention to provide a hollow fiber membrane apparatus for separating a component from a fluid mixture, wherein the fluid flow on the outside of the hollow fiber membranes is evenly distributed and the available membrane surface is fully utilized while the pressure drop of the fluid on the outside of the membrane is very low. Furthermore, flexible adaptation to desired operating conditions should be possible and the design should provide for a reliable sealing between the fluid spaces and facilitate rapid assembly and disassembly and provide for a relatively in-expensive construction.

### SUMMARY OF THE INVENTION

In an apparatus for separating at least one component from a fluid mixture, comprising a plurality of hollow fiber membrane frames through which a carrier fluid is conducted while the fluid mixture flows through the frames in a direction normal to the hollow fiber membranes supported in the frame, a plurality of frames are stacked on top of one another and shaped so that, together, they form a sealed tubular structure for guiding the fluid mixture past the hollow fiber membranes extending across the frames.

The main advantage of the apparatus according to the invention resides in the fact that a very good flow distribution of the gas mixture at the outside of the hollow fiber membranes is achieved and a high material transport with low pressure losses is facilitated. All hollow fiber membranes of the apparatus are uniformly exposed to the fluid mixture flow and the apparatus dimensions can easily be adapted to the desired operating conditions. The apparatus according to the invention is also easily adapted to a modular construction to facilitate construction at low costs.

In a preferred embodiment of the apparatus, the open ends of the hollow fiber membranes, which are suspended in the frame, form the inlets or, respectively, outlets for the carrier fluid flowing through the hollow fiber membranes. It is therefore possible to provide disc-like frames provided with hollow fiber membranes which may be sealingly disposed on top of one another for the operation of the apparatus, but which are not permanently interconnected for example by cementing. This is highly advantageous for maintenance, assembly and replacement purposes.

Because of the material used for the frame and the shape of the frame, the individual frames are sealed directly, for example, with respect to a housing tube whereby the hydraulic separation of the space for the carrier fluid into a feed chamber and a discharge chamber is achieved. At the same time, the individual frames are sealed directly with regard to each other and consequently with regard to the- feed chamber, that is, the space through which the gas mixture-flows.

It has been found that a very good separation result can be achieved if the distance of two adjacent hollow fiber membranes is in the range of 1.5 to 4 times the outer diameter of the hollow fiber membranes.

Preferably, the frames are essentially circular which is very advantageous with respect to the manufacture of the frames and the hollow fiber elements disposed therein. It is however pointed out that the frames do not need to be circular. Any geometric frame shape is possible such as squares, hexagonal or generally n-cornered frame shapes.

Depending on the desired operating conditions, a plurality of frames may be arranged on top of one another to form a membrane stack. Since all the frames with hollow fiber membranes received therein are identical, the apparatus according to the invention can be easily adapted certain desired performance and operating conditions by selecting the number of frames stacked on top of one another. This is generally not possible with the state of the art as described above with woven hollow fiber membranes or rather only if separate sealing elements are disposed between the frames. A stack of frames disposed on top of one another is also mechanically highly stable. There are no problems as to the manufacture and the assembly thereof.

In order to achieve, with stacked frames, a highly effective sweep of the outer surfaces of the hollow fiber membranes of the frames, the stacked frames are rotationally displaced with respect to one another, but the pressure drop caused by a large number of stacked frames remains in acceptable limits. The frames are provided with coding elements by which a particular given orientation of the hollow fiber membrane frames in a stack along the longitudinal axes is ensured. The coding facilitates the arrangement of the stacked frames displaced relative to one another exactly by the code length whereby the assembly of the frame, or respectively, membrane stack is facilitated.

A simple type of coding elements is for example a plurality of holes formed in the frames at defined distances from one another. Upon assembly of a stack, the respective holes are to be in alignment so that a certain displacement of the individual frames corresponding to the selected hole depending on the desired spacing is provided.

It is particularly advantageous with a circular frame if the holes are disposed along a partial circle so that the frame only has to be rotated about the partial circle for causing the respective holes of the stacked frames to be arranged in axial alignment.

Since all the frames can be provided with such holes, only one particular frame shape is required for the whole apparatus. This is highly advantageous for the manufacture and warehousing of the frames.

In another advantageous embodiment of the apparatus, a spacer element is provided in the frame or, respectively, the membrane stack essentially between every two frames arranged on top of one another so that the mechanical stability of the stack of frames is increased in a simple manner and the flow conditions can be better controlled.

The spacer element may include support elements which support the respective adjacent hollow fiber membranes of the frames, for example if the hollow fiber membranes are subjected to a strong gas mixture flow that is if they are also mechanically highly stressed. These support elements may have any form as long as they are capable of fulfilling the support function for the hollow fiber membranes. Preferably, the spacer element comprises a frame like the frame including the hollow fiber membranes that is it has essentially the same outer geometric shape—in a top view as the frame receiving the hollow fiber membranes. The frame however includes at least one web, which interconnects two opposite sides of the frame, the web providing support for the adjacent hollow fiber membranes.

The carrier fluid may flow through all the hollow fiber membranes of the individual frames of the apparatus in a parallel flow pattern. However, for certain applications, it may be advantageous if a frame shaped flow guide element for guiding the carrier fluid is arranged in the frame or the membrane stack. In this way, the carrier fluid can be conducted through the apparatus in a meander-like flow pattern, that is, from frame to frame or, with appropriately arranged guide elements, a partially parallel and partially series flow pattern can be established for the carrier fluid.

For the reversal of the carrier fluid, the guide element is preferably so shaped that, in a first end area, the guide element is smaller than in a second edge area to permit the passage of the carrier fluid. In this way, the carrier fluid can flow around the narrower guide element in the first end area after leaving the outlet of the frame below or above and then enters another corresponding guide element of the frame by which it is guided into the inlets of the hollow fiber elements of this frame.

This flow reversal guide element design can be realized in a simple manner and can be utilized in the stack of frames at the respective desired locations.

The apparatus preferably includes a housing in which the frame or, respectively, membrane stacks are contained while forming a fluid tight space for the carrier fluid between the frames and the housing surface. As housings suitable tube segments may be used, that is unfinished products, of any suitable material. With the advantageous design, a fluid-tight space can be formed in a simple manner. The fluid-tight space, which contains the carrier fluid, can be provided in a simple manner because the frame for the hollow fiber membranes, the frames for the spacer elements and the frame for the guide elements all have the same cross-sectional area—except for the end seals of the housing.

Advantageously, the fluid-tight space is provided in the housing with an inlet and an outlet for the carrier fluid formed simply by bores in the walls of the housing.

In order to provide for an increased mechanical stability of the stack of hollow fiber membrane frames including the spacer elements and of the flow guide elements particularly at the inlet and/or outlet of the housing, the end frames of the membrane stack may include a net-like structure which spans the frame and delimits the inlet or, respectively, outlet of the housing. The net-like structure can be fitted into the end frame element required for containing the membrane stack.

In order to protect the hollow fiber membranes from a possibly highly aggressive medium which may be liquid or gaseous, the hollow fiber membrane is provided at its inner surface with a protective layer consisting for example of silicon.

For particular applications, the hollow fiber membrane may advantageously be micro-porous.

The apparatus is suitable for adding gases to, or removing gases from, liquids, for adding moisture to gases, for membrane separation processes such as pervaporation, dialysis as well as gas separation and for filtration processes with semi-permeable hollow fiber membranes.

An embodiment of the invention will be described below in detail on the basis of the accompanying drawings.

### BRIEF DESCRIPTION OF THE DRAWINGS

FIG. 1 is a top view of a typical frame, which includes a plurality of spaced hollow fiber membranes,

FIG. 2 is a top view of a frame according to FIG. 1 in a base position for forming a frame or membrane stack,

FIG. 3 shows two frames stacked on top of one another and rotated relative to each other by two circle sections,

FIG. 4 shows two frames disposed on top of one another and rotated relative to each other by one circle section,

FIG. 5 shows three frames disposed on top of one another and rotated relative to one another by one circle section,

FIG. 6 shows the arrangement of the hollow fiber membranes in a membrane stack, that is, of two frames of the stack rotationally displaced relative to each other,

FIG. 6A, FIG. 6B and FIG. 6C show axial cross-sections at different locations for showing the spacing between the hollow fiber membranes,

FIG. 7 shows highly schematically, in a cross-sectional view, a frame or membrane stack with upper and lower end members delimiting the frame or membrane stack,

FIG. 8 is a top view of a spacer element including a web for supporting the hollow fiber membranes,

FIG. 9 shows a guide element also including a web for the support of hollow fiber membranes,

FIG. 10 is a cross-sectional view of a housing of the apparatus for receiving a frame or membrane stack possibly with intermediate spacer or guide frames,

FIG. 11 is a top view of the tubular housing shown in FIG. 10,

FIG. 12 shows an end frame as it may be disposed at opposite ends of the stack, the end frame being spanned by a net-like structure,

FIG. 13 is a perspective view of an apparatus including a housing in which a frame or, respectively, membrane stack is disposed,

FIG. 14 shows a frame or membrane stack fully assembled for insertion into the housing according to FIG. 13, in a different view,

FIG. 15 shows the pressure drop over volume flow in a stack for different numbers of frames with hollow fiber membranes,

FIG. 16 shows the pressure drop over volume flow for different orientations of the hollow fiber membranes of the different hollow fiber membrane frames,

FIG. 17 shows the pressure drop over air volume flow for different frame types to show the influence of the diameter of the hollow fiber membrane frame, and

FIG. 18 shows the pressure drop depending on the number of hollow fiber membrane frames in an apparatus wherein the hollow fiber membranes in the different frames are displaced rotationally by 30° and spacer element frames are arranged between the hollow fiber membrane frames.

### DESCRIPTION OF A PREFERRED EMBODIMENT

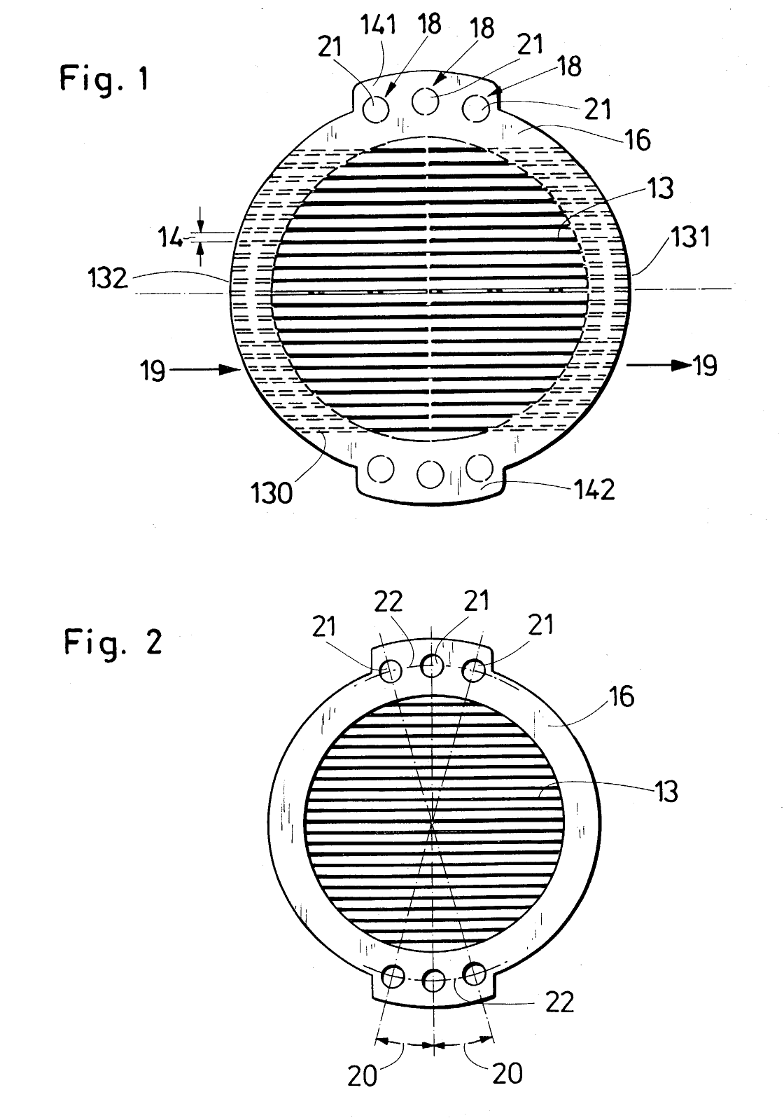

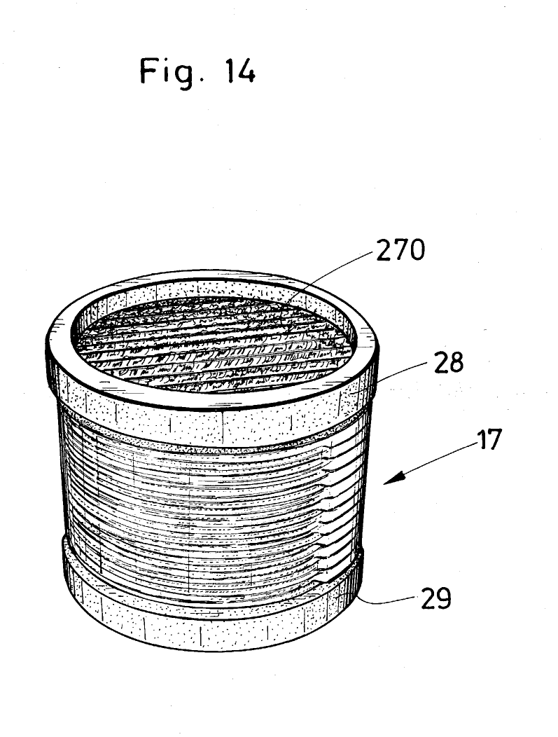

Before describing in detail the apparatus 10 as shown in FIG. 13 reference is first made to FIG. 1 for a description of the design of the frame 16 of which a plurality is employed to form a stack 17 as shown in FIG. 14. The frame 16 which, in the embodiment shown in the figures, is essentially circular (as seen in a top view of the frame 16), comprises a plurality of hollow fiber membranes 13, which are mounted in the frame 16. The individual hollow fiber membranes 13 are arranged at a predetermined distance 14 from one another. The distances 14, however, may be different in different apparatus or even in different frames or an apparatus depending on the mode of operation of the apparatus 10.

Each hollow fiber membrane 13 is stretched across the frame and therefore defines a longitudinal axis 15, with an inlet 31 and an outlet 32 provided at opposite ends of the hollow fiber membrane 13. A carrier fluid 12 flows through the hollow fiber membrane, which will be described below in greater detail.

The frames 16 are cast in a correspondingly shaped mold and the hollow fiber membranes 13, which are pre-fabricated in a well-known manner, are cast into the frame using a suitable castable plastic material which is subsequently permitted to harden. The material, which forms the frame 16, closely encompasses and seals in the hollow fiber membranes 13. As casting material for the frame 16 for example epoxy resin, polyurethane or silicon may be used. A mechanical reinforcement of the frame may be provided for example by a net of plastic or glass or carbon fibers spanning the frame.

After hardening of the castable material, the end sections of the fibers 13 which, during the manufacturing procedure, extend beyond the frame are cut off which may be done by a punching step. The frame 16, which, in the present case, is circular as already pointed out, may however also have another preferably symmetrical shape (in a top view). The frame 16 has furthermore opposite ear-like projection 141, 142, which extend beyond the circular circumference of the frame 16.

The projections 141, 142 include a plurality of coding elements 18, here in the form of holes 21. A rod-like member 180 may be inserted through the holes 21 in order to firmly retain the orientation of the frames relative to each other and of the longitudinal axes 15 of the plane 19 of the hollow fiber elements 13 when a plurality of frames 16 are disposed on top of one another to form the membrane stack 17. Such an arrangement will be described below in greater detail in connection with FIGS. 2, 3, 4 and 5. The holes 21 in the ear-like projections 141, 142 are circumferentially spaced so that the radial lines from the center of the frame 16 to adjacent holes enclose all the same angle. In the arrangement as shown in the drawings, each projection 141, 142 includes three holes 21.

To show various possibilities of stacking the frames 16 to form a frame or, respectively, membrane stack 17 an example with three stacked frames 16 is shown on the basis of a frame 16 as shown in FIG. 2.

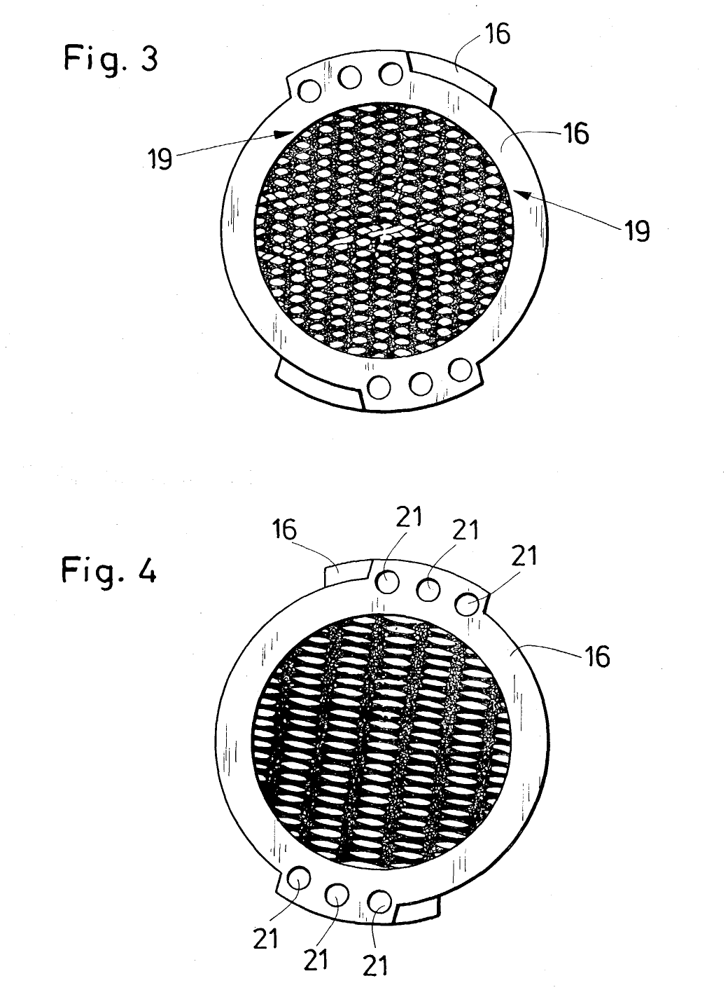

FIG. 3 shows two frames 16 stacked on top of one another which frames are rotated relative to each other by 30° and provide a hollow fiber pattern as shown in the top view of FIG. 3.

In FIG. 4, the two stacked frames are rotated relative to each other by 15°.

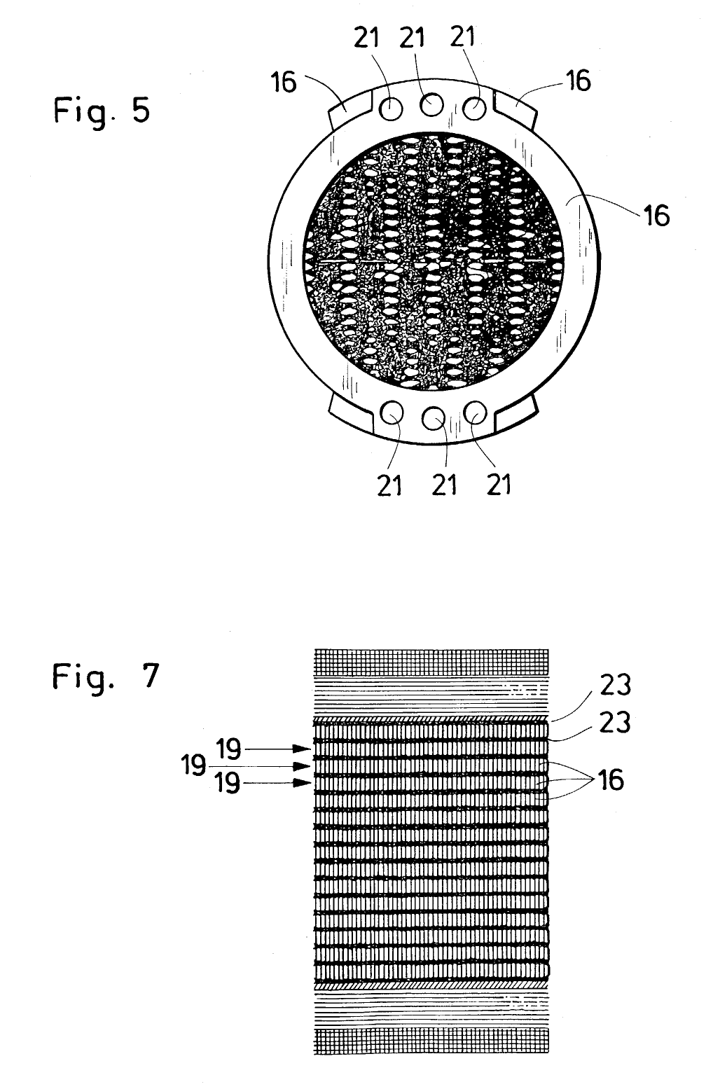

FIG. 5 shows a stack of three frames 16 rotated relative to each other by 15°. In this way, a membrane stack 17 including any desired amount of frames can be formed as shown for example in FIG. 14. The frames 16 may be rotationally displaced relative to one another, in principle, in any way, that is they do not need to be rotated relative to each other as shown herein with a circumferential displacement 20. Since, in the embodiment described above, the holes 21 of the frames are in axial alignment the relative positions of the frames can be fixed in a stack 17 by a rod 180 extending through the respective aligned holes 21 of the frames 16 of the frame or membrane stack.

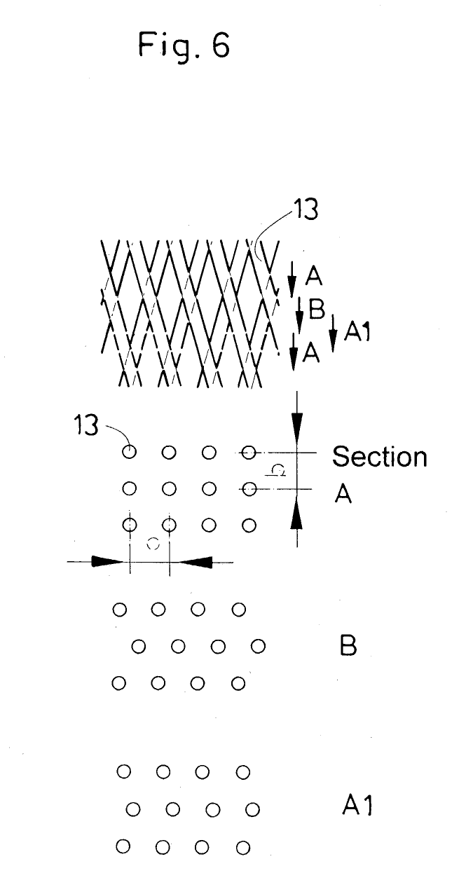

FIG. 6 shows the horizontal positions of the hollow fiber membranes 13 in a membrane stack 17 with two frames 16 rotationally displaced by 30°. FIGS. 6A, 6B and 6C show the hollow fiber membranes in three different vertical cross-sections. “a” indicates the horizontal distance of the hollow fiber membranes in a frame 16 and “b” the vertical distance between the hollow fiber membranes 13 of adjacent frames “a”0 and “b” are indicated as multiples of the outer diameter of the hollow fiber membranes.

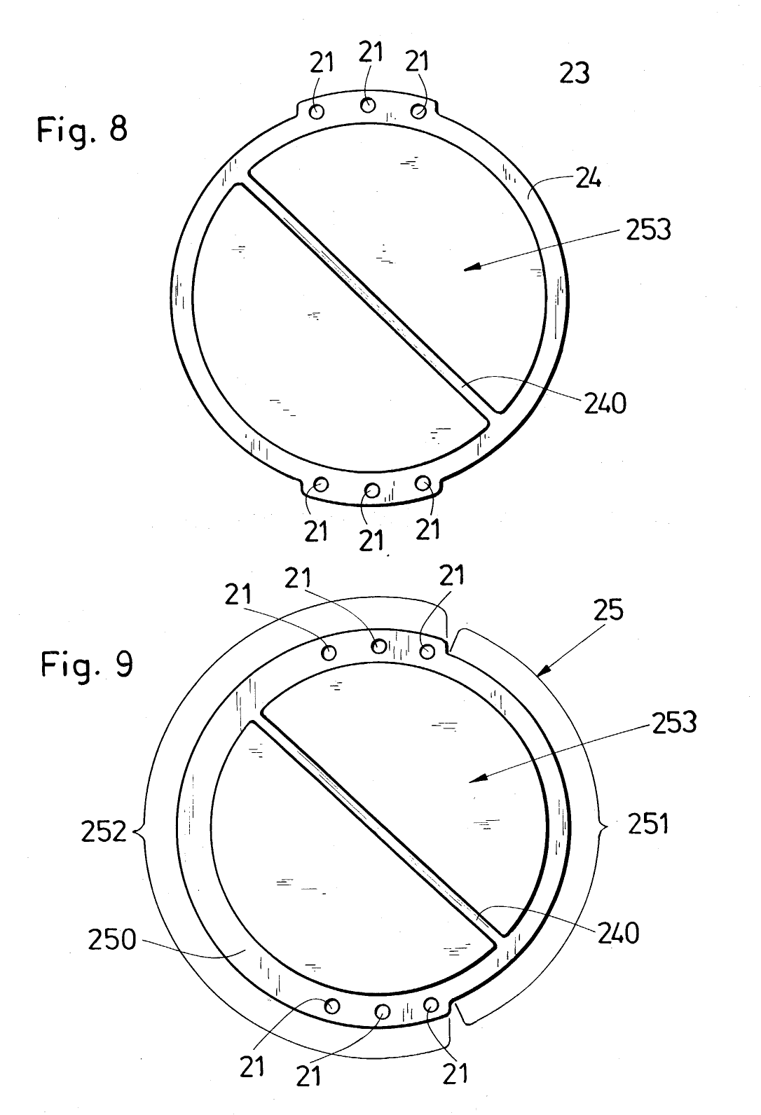

FIG. 7 shows, in a highly schematic way, a portion of a cross-section of a completed membrane stack 17 consisting of a plurality of frames 16. In principle, it shows, arranged between every two frames, spacer elements 23 as they are shown for example in FIG. 8. The spacer elements 23 also have a frame-like structure similar to that of the frames 16, which include the hollow fiber membranes. The holes 21 formed in these frames 24 are also spaced from each other in the same way as the holes 24 in the membrane-containing frames 16. The spacer element 23 includes a web 240, which extends between opposite sides of the frame 24. It is pointed out that the web 240 is shown here only in an exemplary way. It is also possible to provide a plurality of webs for supporting the hollow fiber membranes 13 of the frames 16 if the gas mixture which passes, by the hollow fiber membrane stack has a high flow speed which would elastically bend the hollow fiber membranes excessively. By providing support structures of spaced webs 240 for the hollow fiber membranes, the unsupported length of the hollow fiber membranes 13 is reduced.

A spacer function and/or a support function can also be provided by the guide element 25 shown in FIG. 9. The guide element 25 is also shaped like the frame 16, which receives the hollow fiber membranes 13. At its outer circumference, the guide element 25 includes a frame 250 with a first peripheral area 251 and a second peripheral area 252. The first peripheral area 251 of the frame 250 is in the plane 253 of the guide element narrower than the second peripheral area 252. The narrower peripheral area 251 provides for a passage along the inside wall of the housing 26 for the carrier fluid 26, which flows into the inlets 131 for the interior 130 of the hollow fiber membranes 131 of the adjacent frames or which flows out of the outlets 232 of the hollow fiber membranes 13. The second peripheral area 252 is, in the plane 253 of the guide element 25, so sized that it abuts the inside wall 261 of the housing and, with suitable material disposed at its circumferential edge, forms an end seal with respect to the wall housing 26. The holes 21 in the guide element 25 are uniformly spaced from one another at the same distance as the holes 21 of the spacer elements 23. The guide element 25 may also include support webs 240 as described already in connection with the spacer element 24, or other suitable support elements for supporting the hollow fiber membranes and also for increasing the stability of the guide element 25.

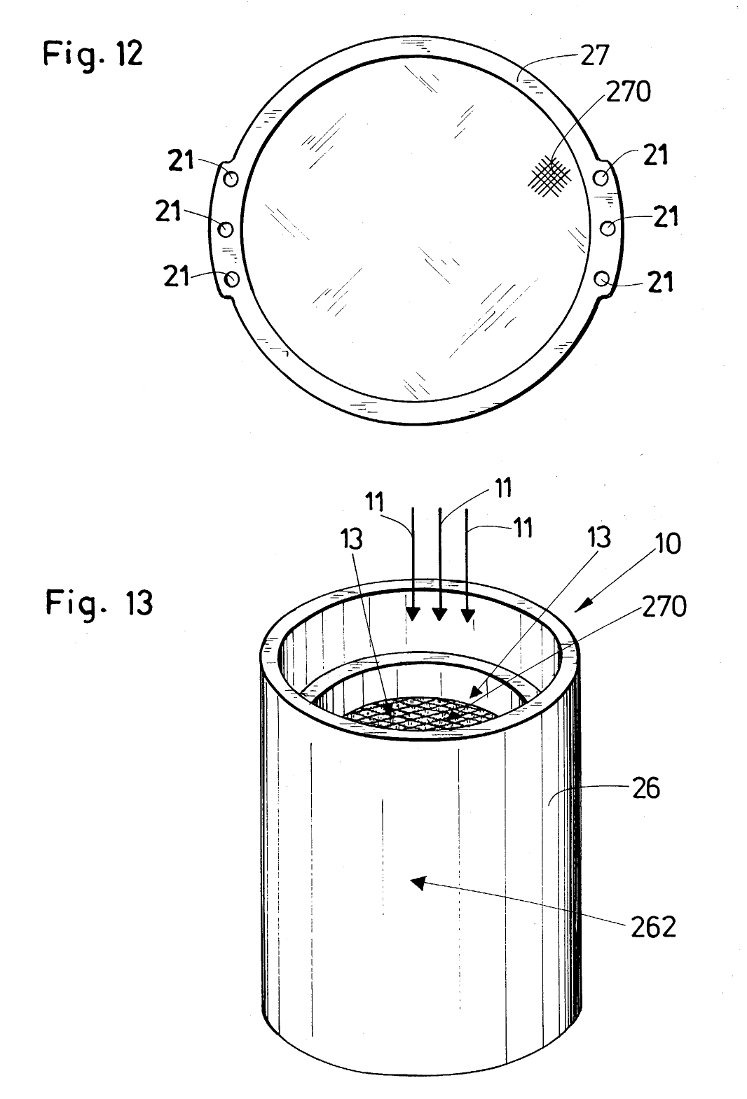

The frame or membrane stack 17 as it is shown preassembled in FIG. 14 for insertion into the housing 26 (see also FIGS. 19 and 11) may also include a circular frame 27 (see FIG. 12) which, with regard to the representation of FIG. 14, delimits the frame or membrane stack 17 at its upper or lower end. The frame 27 has a similar structure as the frame 24 of the spacer element 23, that is with respect to the outer dimensions and the shape thereof, wherein the holes 21 are shaped and arranged in the same way as they have been described for the frame 16, the spacer element 23 and the guide element 25. They have the same size and the same distance from one another and from the center axis of the frame 27. The frame 27 is provided with a net-like structure 270. Such net-like structure may also be fitted directly into a respective groove of the pressure member 28.

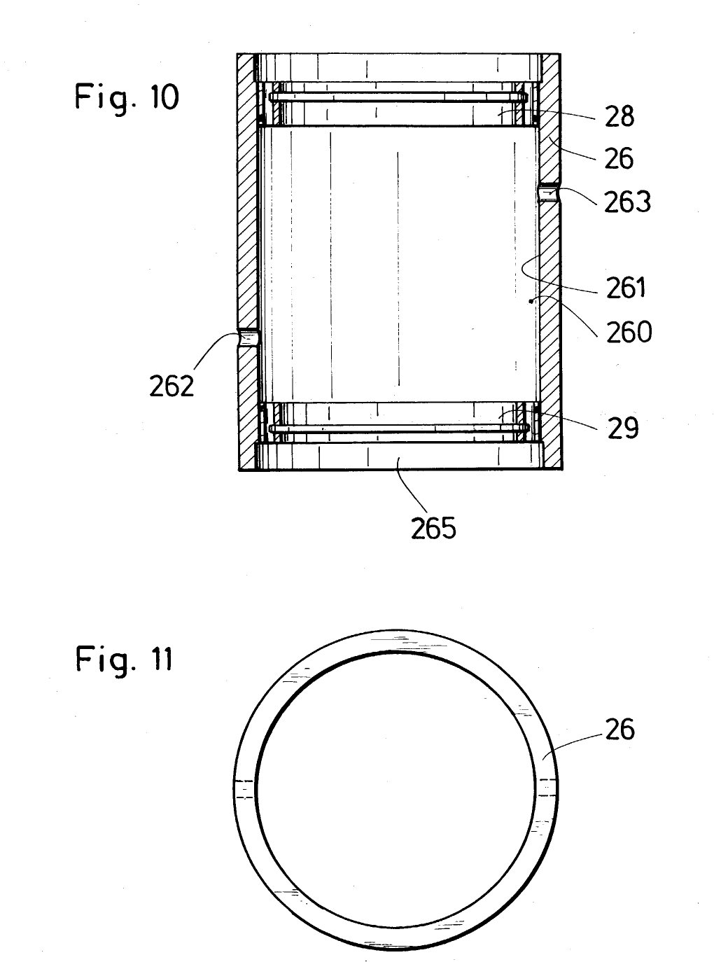

The frame or membrane stack 17 shown in FIG. 14 includes at its opposite axial ends similar pressure members 28, 29, which, in connection with the housing 26 (see FIG. 10), contain the frame or membrane stack in a pressure-sealed fashion. The frames 16, the spacer elements 23, the guide elements 25 and the end frames 27 with the net-like structures 270 are engaged in a pressure-tight manner so that a fluid-sealed space 260 is formed between the frame or membrane stack 27 and the inner wall 261 of the housing. The carrier fluid 12 flows from an inlet 262 to an outlet 263 either parallel, partially parallel, or in a meander-like fashion through the hollow fiber membranes of the frames 16.

With a suitable shape of the elements and a selection of suitable materials for the frame 16, the spacer elements 23 and/or the guide elements 25 and/or the end frames 27, the fluid tight space 260 can be formed within the inner housing surface without special sealing measures or sealing means. In this way, as shown in FIG. 13, the gas mixture 11 is conducted essentially vertically onto the hollow fiber membranes 13 whereby the gas mixture 11 flows through the tubular housing 26 from the inlet opening 264 to the outlet opening 265 while at least one component of the gas mixture 11 permeating through the walls of the hollow fiber membranes 13 is adsorbed or absorbed by the carrier fluid 12 which flow through the hollow fiber membranes 13.

Below some measurement results are presented on the basis of five examples which confirm the excellent operational results of the apparatus according to the invention as derived originally by theoretical considerations.

The pressure losses occurring in the gas mixture 11 flowing through the stack of hollow fiber membranes in the housing 26 in a direction normal to the axes of the hollow fiber membranes 13 was measured. For measuring the flow volume, a manometer was used. The pressure was measured at the inlet and the outlet of the apparatus 10 with inclined tube manometers. The number and orientation of the frames 16 with hollow fiber membranes 13 was varied. The outer diameter of the hollow fiber membranes 13 used was 1.0 mm. The gas mixture was conducted over the outer surface of the hollow fiber membranes 13.

For comparison, two conventional apparatus (with hollow fiber membrane bundles disposed axially in a tubular housing) were measured.

### EXAMPLE 1

An apparatus 10 according to the invention with cross-flow was constructed and measured. The apparatus 10 included 40 frames 16 each with hollow fiber membranes 13 of a type II. The inner open diameter of the frames 16 of the type II was 165 mm, the thickness of the frame 26 was 2 mm. The frames 16 each included 51 hollow fiber membranes 13. The orientation of the hollow fiber membranes of the frames differed by 30°. Spacer frames 24 were disposed between the hollow fiber membrane frames 16. The spacer frames 24 were so arranged that the transverse support webs of subsequent spacer frames 24 extended at an angle of 90° relative to one another. The thickness of the spacer frames 24 was 1 mm. The distances between the hollow fiber membranes 13 was a=3, b=3 mm. The outer membrane surface area was 0.83 m². For comparison, two conventional apparatus designated “A” and “B” were measured. These apparatus had the following features:

Inner diameter of the tubular housing: A=43 mm, B=55 mm; outer diameter of the hollow fiber membranes: A=1.2 m; B=1.0 mm. Number of hollow fiber membranes in the bundle: A=660; B=1300. Outer membrane surface area A=0.76 m²; B=1.3 m². The number of the hollow fiber membranes in each bundle was so selected that channel formation as a result of an overly loose packing was avoided. The results are presented in the following table.

TABLE 1
Pressure loss comparison with conventional appa-
ratus with cross flow, pressure drop given in Pa.

| | Volume flow m³h | | | |
|---|---|---|---|---|
| | type/membrane | | | |
| | surface area | 10 | 90 | 200 |
| Conventional | B/1.3 m² | 400 | — | — |
| | A/0.76 m² | 600 | — | — |
| Cross flow | Type II/0.83 m² | <10 | 30 | 130 |
| apparatus | | | | |

The pressure drop in the apparatus 10 according to the invention as measured is substantially lower than in conventional apparatus.

### EXAMPLE 2

Influence of the diameter of the frames 16 provided with hollow fiber membranes 13:

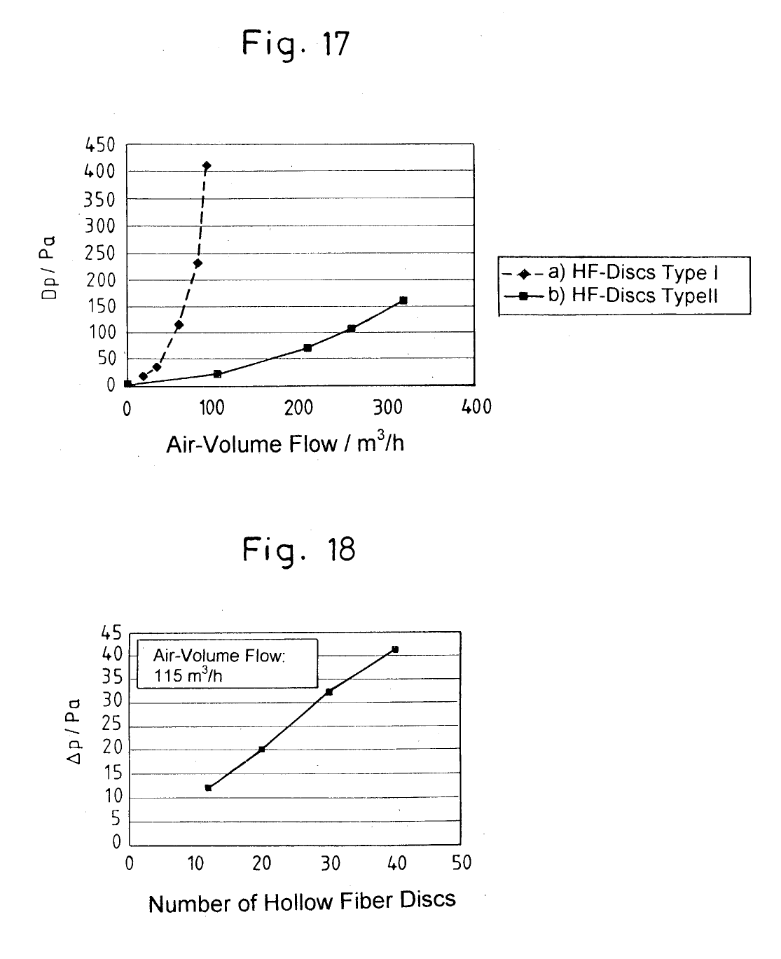

Two apparatus 10 according to the invention were constructed. The apparatus 10 included each 20 frames 16 having hollow fiber membranes 13. The first apparatus 10 with frames 16 of the type I, the second apparatus 10 with frames of the type II. The inner diameter of the frame 16 of type I was 75 mm, the thickness of the frame was 2 mm. The frames included each 21 hollow fiber membranes. The orientation of the hollow fiber membranes was different by 30°. Between the frames 16 spacer frames 24 of the type S1 or, respectively, S3 were inserted. The inner diameter of the spacer frame 24 of the type S1 was 75 mm, the thickness was 1 mm. The spacer frame 24 had no transverse webs 240. The inner diameter of the spacer frame of the type S3 was 165 mm, the thickness was 1 mm. The spacer frame 24 included a transverse web 240. The outer membrane surface area of the first apparatus 10 was 0.088 m², that of the second apparatus 10 was 0.42 m². The distances between the hollow fiber membranes 13 in both apparatus 10 were a=3, b=3 mm. The results are represented in FIG. 17.

### EXAMPLE 3

Dependency of the pressure drop on the number of frames 16 provided with hollow fiber membranes 13.

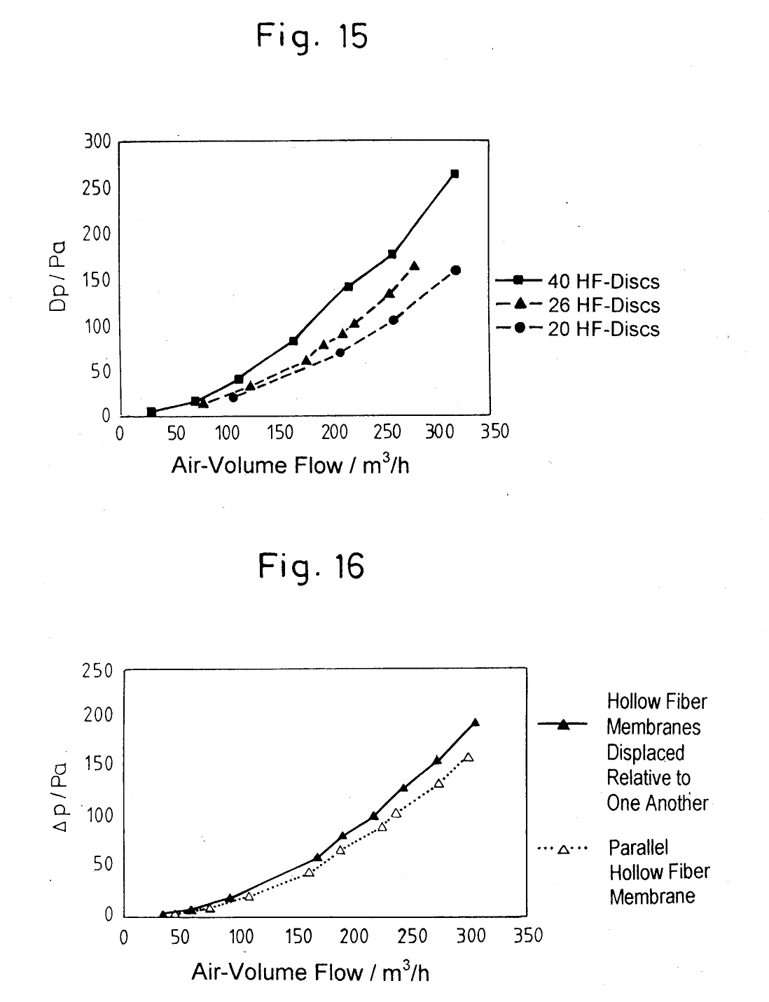

Apparatus 10 with different numbers of frames of the type II were manufactured. The orientation of the hollow fiber membranes 13, the arrangement of the spacer elements 23 and the spacer dimensions “a” and “b” corresponded to those as given in example 2. The frames 16 provided with hollow fiber membranes 13 were subjected to a gas flow of 115 m³/h: An almost linear dependency of the pressure drop on the number of frames provided with hollow fiber membranes 13 was determined as shown in FIG. 15.

### EXAMPLE 4

Dependency of the pressure drop on the volume flow:

Three apparatus with 20, 26 and 40 frames 16 of the type II with hollow fiber membranes 13 were constructed. Distances orientation and arrangement of the spacer frames 24 were as in example 2. The respective membrane surface areas (outer surface area of the hollow fiber membranes) were 0.42 m²; 0.54 m² and 0.83 m². The volume flow passing over the hollow fiber membranes was changed. FIG. 15 shows the dependency of the pressure drop on the volume flow.

### EXAMPLE 5

Influence of the orientation of the hollow fiber membranes 13:

Two apparatus 10 each including 26 frames 16 provided with hollow fiber elements 13 were constructed. The hollow fiber membrane orientations of different frames was varied between parallel and displaced by 30°.

The pressure drop measured independence on the volume flow is shown in FIG. 16.

FIG. 17 shows the pressure drop depending on volume flow for different types of hollow fiber membrane frames (Type I, II) and

FIG. 18 shows the pressure drop depending on the number of hollow fiber membrane frames for a gas volume flow of 115 m³/h.

What is claimed is:

1. An apparatus for separating at least one component from a fluid mixture, comprising a plurality of frames, each frame including a plurality of hollow fiber membranes extending across said frame in parallel spaced relationship and being open at opposite ends of said frame for conducting a carrier fluid through said hollow fiber membranes, while said fluid mixture flows through said frames in a direction normal to the axes of said hollow fiber membranes supported in said frames, said plurality of frames being stacked on top of one another and being so shaped that they form a sealed tubular structure for guiding said fluid mixture through said frames past said hollow fiber membranes extending across said frames.

2. An apparatus according to claim 1, wherein said open ends of said hollow fiber membranes form inlet and outlet openings for the carrier fluid flowing through said hollow fiber membrane.

3. An apparatus according to claim 1, wherein said hollow fiber membranes are arranged at a distance from one another which is 1.5 to 4 times the outer diameter of the hollow fiber membranes.

4. An apparatus according to claim 1, wherein said frames are essentially circular.

5. An apparatus according to claim 1, wherein a plurality of said frames are arranged on top of one another to form a hollow fiber membrane stack.

6. An apparatus according to claim 1, wherein said frames include coding elements by way of which adjacent frames can be joined in a predetermined manner so as to provide for a predetermined orientation of the longitudinal axes of the hollow fiber membranes in adjacent frames relative to each other.

7. An apparatus according to claim 6, wherein said coding elements comprise a plurality of holes formed in the frames at predetermined distances from one another.

8. An apparatus according to claim 7, wherein, with a circular frame, said holes are formed along a partial circle.

9. An apparatus according to claim 5, wherein spacer elements are disposed between every two frame members disposed on top of one another in said stack.

10. An apparatus according to claim 9, wherein each of said spacer elements consists of a frame corresponding to the hollow fiber membrane frame, said spacer element frame including at least one support web extending between opposite parts of said spacer element frame.

11. An apparatus according to claim 5, wherein guide frames are disposed in said stack of membrane elements, each guide frame including a guide structure for guiding the carrier fluid.

12. An apparatus according to claim 11, wherein said guide structure in a circumferential first part of said guide frame is narrower than in an other circumferential part to permit passage of the carrier fluid.

13. An apparatus according to claim 5, wherein said stack of said frames is disposed in a housing providing between said frames and the housing a fluid-tight space for containing the carrier fluid.

14. An apparatus according to claim 13, wherein said frames consist of a material and have a shape by which said carrier fluid space is sealed with respect to the surrounding housing wall.

15. An apparatus according to claim 13, wherein said housing is provided with an inlet and an outlet for conducting said carrier fluid to and from said sealed space.

16. An apparatus according to claim 5, wherein said hollow fiber membrane stack includes at least one frame element which, in shape, corresponds to a hollow fiber membrane frame but which is provided with a net-like structure spanning the frame.

17. An apparatus according to claim 1, wherein said hollow fiber membranes are coated at their inner surfaces with silicone.

18. An apparatus according to claim 1, wherein said hollow fiber membranes are micro-porous.

19. An apparatus according to claim 1, for at least one of supplying gases to, or removing gases from liquids, the humidification of gases, membrane processes including pervaporation, dialysis, gas separation and filtration processes with semipermeable hollow fiber membranes.
